(19) United States
(12) Patent Application Publication
(10) Pub. No.: US 2022/0152957 A1
(43) Pub. Date: May 19, 2022

(54) CARBON FRAME FOR CHILD CARSEAT

(71) Applicant: BabyArk LTD, Hevel ModiIn Industrial Park (IL)

(72) Inventors: Anan HASAN, Julis (IL); Shy MINDEL, Hod-HaSharon (IL)

(73) Assignee: BabyArk LTD, Hevel ModiIn Industrial Park (IL)

(21) Appl. No.: 17/438,435

(22) PCT Filed: Mar. 12, 2020
(86) PCT No.: PCT/IL2020/050300

§ 371 Date: Sep. 12, 2021

Related U.S. Application Data
(60) Provisional application No. 62/817,038, filed on Mar. 12, 2019.

(51) Int. Cl. B29C 70/86; B29C 70/20; B29C 70/34; B29B 11/16; B60N 2/26; B60N 2/68

(52) U.S. Cl. CPC B29C 70/86; B29C 70/205; B29C 70/345; B29L 2031/771; B60N 2/26; B60N 2/68; B29B 11/16

(57) ABSTRACT

A child car seat comprises a curvilinear frame. The frame includes right and left monolithic multilayered carbon fiber sidewalls each having a head retaining region and a bottom region connected by a central region. At least one beam connects one of the right and left monolithic multilayered carbon fiber sidewalls with the other. At least 20% of the surface area of each of the head retaining region and the bottom region is a hollow space. The right and left sidewalls are manufactured by placing carbon fibers and polymer to form a carbon fiber preform having a plurality of layers, each with a predefined orientation; and heating or curing the carbon fiber preform so that the polymer forms a matrix that binds the plurality of carbon fiber layers.

### RELATED APPLICATION/S

This application claims the benefit of priority of U.S. Provisional Patent Application No. 62/817,038, filed on Mar. 12, 2019, entitled “Carbon Frame,” the contents of which are incorporated herein by reference in their entirety.

### BACKGROUND

The present invention, in some embodiments thereof, relates to a child car seat and, more particularly, but not exclusively, to a curvilinear frame for a child car seat made from monolithic multilayered carbon fiber sidewalls connected by one or more beams.

Child car seats are typically made of a molded plastic frame overlaid with a padded cover. Due to limited space in a vehicle, it is desirable to have a car seat that is as narrow as possible. On the other hand, it is desirable to have a foam padding that provides comfort to the child in the car seat.

One advantage of car seat frames made of molded plastic is that the frames may be produced relatively inexpensively. However, the plastic in car seats degrades over time, due to exposure to rapid temperature changes that occur in the vehicle environment. As a result, all car seats with plastic frames have expiration dates, typically five years.

Carbon fiber is known as a lightweight, and extremely strong, material. Carbon fiber is widely used in various applications, such as air plane structures, frames of high-end bicycles, fishing rods, automated machine parts, and insoles of running shoes. A child car seat frame may also be made of carbon fiber, as disclosed in International Patent Publication WO 2017/216649, the contents of which are incorporated by reference as if fully set forth herein. Carbon fiber does not degrade over time, and thus poses distinct advantages for use in car seat frames over plastic. In addition, it is very light and very strong. These two characteristics provide great advantage both in everyday use and crash scenarios.

Carbon fiber is typically incorporated into manufactured products as carbon fiber reinforced polymer. In the traditional manufacture of carbon fiber reinforced polymer, unidirectional or multidirectional (e.g., ±90 degrees, ±45 degrees) sheets of woven carbon fiber are layered over each other. Each sheet has fibers woven in two directions (warp and weft) and not following a unique geometry. The sheets may be angularly displaced relative to each other, typically at 45 or 90 degree angles. A binding polymer, such as a polymer resin, is introduced between the different layers. The carbon fiber layers may also be pre-impregnated (pre-preg) with the resin. The polymer resin is impregnated throughout the carbon fiber layers, for example, with a vacuum or an autoclave, and is cured, resulting in the finished carbon fiber reinforced polymer. This method of manufacture often results in high wastage, because control of the force vector for the carbon fiber is limited by the geometry of the carbon fiber sheets, and portions of the carbon fiber sheets that do not fit the desired shape are removed and discarded.

A recently developed method of manufacturing with carbon fibers is known as tailored fiber placement (TFP). In tailored fiber placement, carbon fiber thread is stitched with a stitching head onto a base material. The stitching head is equipped with a roving spool, pipe, and needle and can rotate arbitrarily in 360 degrees. The fibers may be stitched in multiple layers, at different angles, according to the requirements of the final product. In addition, the stitching head only stitches the carbon fiber to the base material only at regular intervals, rather than continuously. Anchoring the thread only at a few key points enables the carbon fiber to deform into complex 3D shapes when cured or pressed into a mold. The fibers used in tailored fiber placement may be purely carbon fiber, or a yarn formed of carbon fiber commingled with a polymer. Tailored fiber placement thus allows complex 3D shapes to be created from a 2D preform in a quick and consistent way, with virtually no waste of carbon fiber. The principles of tailored fiber placement can be applied to all kinds of fibers, including glass fibers, natural fibers and more.

### SUMMARY

The high cost of carbon fiber poses a challenge for including carbon fiber in car seat frames. This is especially the case because carbon fiber exhibits maximum strength only when the fiber grains are aligned with the direction of force. A child car seat must be capable of absorbing impacts in multiple directions, including front, rear, and side impacts. Accordingly, for car seat frames, multiple layers of carbon fiber, oriented in different directions, are required. The resulting expense renders a car seat frame made of conventionally manufactured carbon fiber prohibitively expensive. In addition, it is desirable to minimize the wastage in the manufacturing process.

It is accordingly an object of the present invention to provide a cost-effective, strong, efficiently manufactured child car seat base made of carbon fiber.

According to a first aspect, a child car seat comprises a curvilinear frame. The frame includes right and left monolithic multilayered carbon fiber sidewalls each having a head retaining region and a bottom region connected by a central region. At least one beam connects one of the right and left monolithic multilayered carbon fiber sidewalls with the other. At least 20% of the surface area of each of the head retaining region and the bottom region is hollow space. Advantageously, the sidewall structure, and the presence of the hollow space reduces the amount of carbon fiber required to form the child car seat, without compromising on the structural integrity of the car seat. The multilayered carbon fiber sidewalls each provide sufficient strength to the car seat.

In another implementation according to the first aspect, each sidewall comprises at least one rib with a curved surface, and at least a portion of the curved surface has a concave indentation.

The concave indentation promotes the structural integrity of the rib as it is shaped into its position as part of the sidewall. Optionally, at least one V-shaped plastic strengthener is attached to the concave indentation. The V-shaped strengthener provides further structural support.

In another implementation according to the first aspect, the hollow space in the bottom region comprises two or more holes, the holes are substantially aligned on a horizontal axis of the bottom region, and each hole is bounded by an upper rib, a lower rib, and at least one strut oriented substantially perpendicular to the horizontal axis. Advantageously, the struts provide additional support and thus enable the total amount of hollow space to be increased without compromising on the strength of the sidewall.

In another implementation according to the first aspect, a ratio of a width of each strut to its height is between 10% and 200%. The strut may be dimensioned according to the size and strength requirements of the child car seat.

In another implementation according to the first aspect, for each sidewall, the hollow space of the bottom region has at least three bottom region holes, and the hollow space of the head retaining region comprises at least three head retaining holes. The presence of three holes ensures that a corresponding amount of supporting struts are placed to provide structural support to the sidewall.

In another implementation according to the first aspect, the at least one beam comprises an upper beam joining the sidewalls above the head retaining region, and a lower beam joining the sidewalls below the bottom region. This configuration provides two secure connection points at edges of the child car seat, in locations that do not interfere with the functioning of the child car seat.

According to a second aspect, a child car seat comprises a curvilinear frame. The frame comprises right and left monolithic carbon fiber sidewalls each having a head retaining region and a bottom region connected by a central region. At least one beam connects one of the right and left monolithic multilayered carbon fiber sidewalls with the other. Each of the right and left sidewalls comprises at least one bottom region hollow space and at least one head retaining region hollow space. The right sidewall and the left sidewall are each manufactured by placing carbon fibers and a polymer to form a carbon fiber preform having a plurality of layers, each with a predefined orientation, and heating or curing the carbon fiber preform so that the polymer forms a matrix that binds the plurality of carbon fiber layers. Advantageously, the placement of the carbon fiber in layers with predefined orientations ensures that the car seat frame is thus manufactured with virtually no waste of carbon fibers, because carbon fiber is placed only in predefined orientation. In addition, the presence of hollow space reduces the amount of carbon fiber required to form the right and left sidewalls, without compromising on the structural integrity of the panels. Each of the carbon fiber layers may be oriented in a specific direction, so as to maximize the strength of the carbon fiber reinforced polymer against forces applied in that direction.

In another implementation according to the second aspect, at least 20% of the surface area of each of the head retaining region and the bottom region is a hollow space. The presence of the hollow space reduces the amount of carbon fiber required to form the child car seat, thus reducing the need for carbon fiber in the entire car seat, and reducing the expense of manufacture. At the same time, each sidewall has sufficient carbon fiber to ensure strength of the panel.

In another implementation according to the second aspect, each sidewall comprises at least one rib with a curved surface, and at least a portion of the curved surface has a concave indentation. The concave indentation may be formed during the heating or curing process, and it promotes the structural integrity of the rib as it is shaped into its position as part of the sidewall. Optionally, at least one V-shaped plastic strengthener is attached to the concave indentation. The V-shaped strengthener provides further structural support, beyond the structural support that is achieved through the bonds of the polymer matrix.

In another implementation according to the second aspect, the hollow space in the bottom region comprises two or more holes, the holes are substantially aligned on a horizontal axis of the bottom region, and each hole is bounded by an upper rib, a lower rib, and at least one strut oriented substantially perpendicular to the horizontal axis. Advantageously, the struts provide additional support and thus enable the total amount of hollow space to be increased without compromising on the strength of the sidewall. Optionally, a ratio of a width of each strut to its height is between 10% and 200%. The strut may be dimensioned according to the size and strength requirements of the child car seat.

In another implementation according to the second aspect, for each sidewall, the hollow space of the bottom region has at least three bottom region holes, and the hollow space of the head retaining region comprises at least three head retaining holes. The presence of three holes ensures that a corresponding amount of supporting struts are placed to provide structural support to the sidewall.

In another implementation according to the second aspect, at least one of the plurality of carbon fiber layers is formed in a closed geometric shape that encompasses the head retaining region, the central region, and the bottom region. This closed geometric shape provides structural integrity to the entire sidewall, by protecting against a force resulting from lateral impact against the sidewall.

In another implementation according to the second aspect, the carbon fiber and polymer are in the form of a commingled yarn during placing step. Commingling the polymer and carbon fiber provides for a more efficient placement of the fiber and polymer as opposed to separately applying the fiber and polymer.

In another implementation according to the second aspect, each of the right and left sidewalls further comprises metal inserts that are heated or cured together with the carbon and polymer. The metal inserts provide further structural strength to the sidewalls.

In another implementation according to the second aspect, each of the right and left sidewalls further comprises a plastic layer that is over-molded onto the carbon fiber preform during the heating or curing process. The plastic layer provides further structural strength to the sidewalls.

According to a third aspect, a method of manufacturing a child car seat comprises forming right and left monolithic multilayered carbon fiber sidewalls. Each of the right and left sidewalls comprises at least one bottom region hollow space, and at least one head retaining region hollow space. The method further comprises joining the right and left sidewalls with at least one beam. The forming step comprises placing carbon fibers and polymer to form a carbon fiber preform having a plurality of layers, each with a predefined orientation, and heating or curing the carbon fiber preform so that the polymer forms a matrix that binds the plurality of carbon fiber layers. Advantageously, placing the carbon fiber in layers with predefined orientations ensures that the car seat frame is thus manufactured with virtually no waste of carbon fibers, because carbon fiber is placed only in predefined orientation. In addition, the presence of hollow space reduces the amount of carbon fiber required to form the right and left side sidewalls, without compromising on the structural integrity of the panels. Each of the carbon fiber layers may be oriented in a specific direction, so as to maximize the strength of the carbon fiber reinforced polymer against forces applied in that direction.

In another implementation according to the third aspect, at least 20% of the surface area of each of the head retaining region and the bottom region is a hollow space. The presence of the hollow space reduces the amount of carbon fiber required to form the child car seat, thus reducing the need for carbon fiber in the entire car seat, and reducing the expense of manufacture. At the same time, each sidewall has sufficient carbon fiber to ensure strength of the panel.

In another implementation according to the third aspect, the method further comprises forming in each sidewall at least one rib with a curved surface, wherein at least a portion of the curved surface has a concave indentation. The concave indentation promotes the structural integrity of the rib as it is shaped into its position as part of the sidewall. Optionally, the method comprises attaching at least one V-shaped plastic strengthener to the concave indentation. The V-shaped strengthener provides further structural support, beyond the structural support that is achieved through the bonds of the polymer matrix.

In another implementation according to the third aspect, the hollow space in the bottom region comprises two or more holes, wherein said holes are substantially aligned on a horizontal axis of the bottom region, and each hole is bounded by an upper rib, a lower rib, and at least one strut oriented substantially perpendicular to the horizontal axis. Advantageously, the struts provide additional support and thus enable the total amount of hollow space to be increased without compromising on the strength of the sidewall. Optionally, a ratio of a width of each strut to its height is between 10% and 200%. The strut may be dimensioned according to the size and strength requirements of the child car seat.

In another implementation according to the third aspect, the method further comprises embroidering at least one of the plurality of carbon fiber layers in a closed geometric shape that encompasses the head retaining region, the central region, and the bottom region. This closed geometric shape provides structural integrity to the entire sidewall, by protecting against a force resulting from lateral impact against the sidewall.

In another implementation according to the third aspect, the carbon fiber and polymer are in the form of a commingled yarn during the placing step. Commingling the polymer and carbon fiber provides for a more efficient placement of the fiber and polymer as opposed to separately applying the fiber and polymer.

In another implementation according to the third aspect, the heating or curing step further comprises heating or curing metal inserts together with the carbon and polymer. The metal inserts provide further structural strength to the sidewalls.

In another implementation according to the third aspect, the method further comprises over-molding a plastic layer onto the carbon fiber preform during the heating or curing process. The plastic layer provides further structural strength to the sidewalls.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a left perspective view of a frame for a child car seat, according to embodiments of the invention;

FIG. 2 is a right perspective view of the child car seat frame of FIG. 1;

FIG. 3A is a schematic depiction of a right sidewall of the child car seat frame of FIG. 1, according to embodiments of the invention;

FIG. 3B is a right perspective view of the right sidewall of FIG. 3, according to embodiments of the invention;

FIG. 4 is a depiction of embroidery machinery stitching carbon fiber to form a carbon fiber preform, according to embodiments of the invention;

FIG. 5A is a depiction of a two-dimensional carbon fiber preform stitched to a substrate, according to embodiments of the invention;

FIG. 5B is a close-up view of the depiction of FIG. 5A;

FIG. 6 depicts orientations of separate layers of carbon fiber that are overlaid to form a carbon fiber preform, according to embodiments of the invention;

FIG. 7 depicts a two-dimensional carbon fiber preform of a sidewall of a child car seat frame, according to embodiments of the invention;

FIGS. 8A-8C depict alternative patterns for layers of carbon fiber, according to embodiments of the invention;

FIG. 9A is a depiction of a prior art, 90 degree bending pattern in a carbon fiber reinforced polymer;

FIG. 9B is a depiction of a curvilinear bending pattern in a carbon fiber reinforced polymer, with a concave underside molded into a W-shaped cross section according to embodiments of the invention;

FIG. 10A is a depiction of a mold for generating a W-shaped cross section in a carbon fiber reinforced polymer, according to embodiments of the invention;

FIG. 10B is a depiction of the mold of FIG. 11A forming a W-shaped cross-section, according to embodiments of the invention;

FIG. 11A is a depiction of a U-shaped curvature in a carbon fiber reinforced polymer;

FIG. 11B is a depiction of a different U-shaped curvature in a carbon fiber reinforced polymer, according to embodiments of the invention;

FIG. 11C is a depiction of plastic strengtheners for U-shaped curves in a carbon fiber reinforced polymer, according to embodiments of the invention; and

FIG. 12 is a left perspective view of a second embodiment of a car seat frame, according to embodiments of the invention.

### DETAILED DESCRIPTION

The present invention, in some embodiments thereof, relates to a child car seat and, more particularly, but not exclusively, to a curvilinear frame for a child car seat made from monolithic multilayered carbon fiber sidewalls connected by one or more beams.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

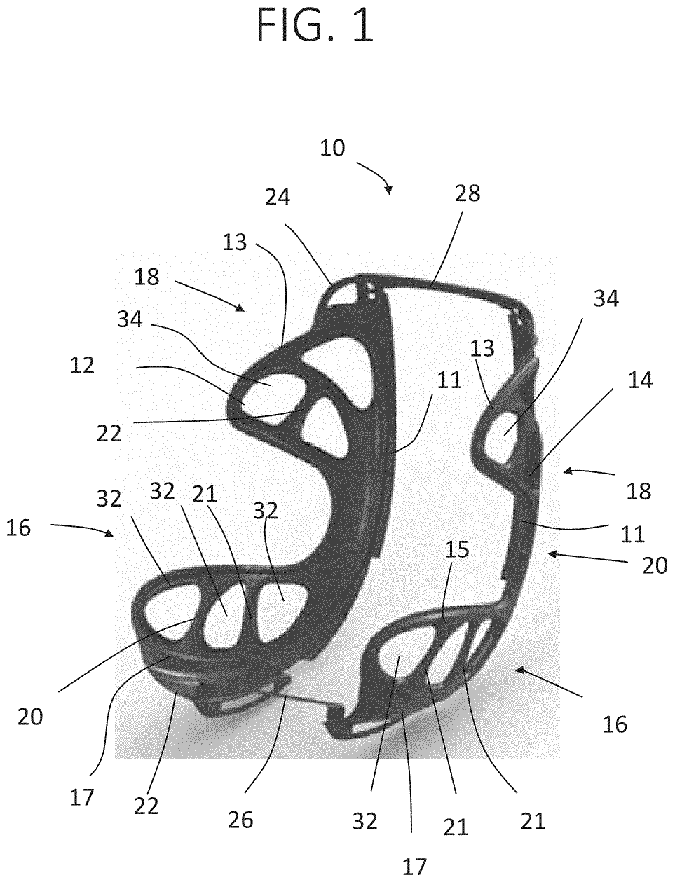

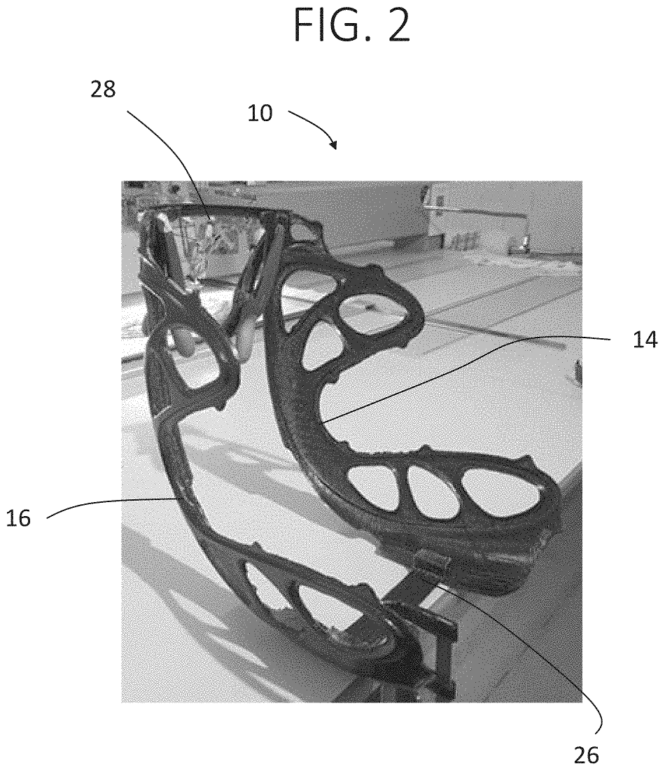

Referring to FIG. 1 and FIG. 2, child car seat frame 10 consists of a right sidewall 12 and a left sidewall 14. Both right sidewall 12 and left sidewall 14 are made of a fiber reinforced polymer. The fiber may be any fiber that is known or that may later become known that is suitable for inclusion in a fiber reinforced polymer, for example, carbon fiber, glass fibers, natural fibers, hemp fibers, basalt fibers, aramid fibers, or any combination thereof. In a preferred embodiment, the fiber is carbon fiber. The example of carbon fiber is used in the remainder of the present disclosure for exemplary purposes only, and is not to be understood as limiting or excluding other suitable fibers.

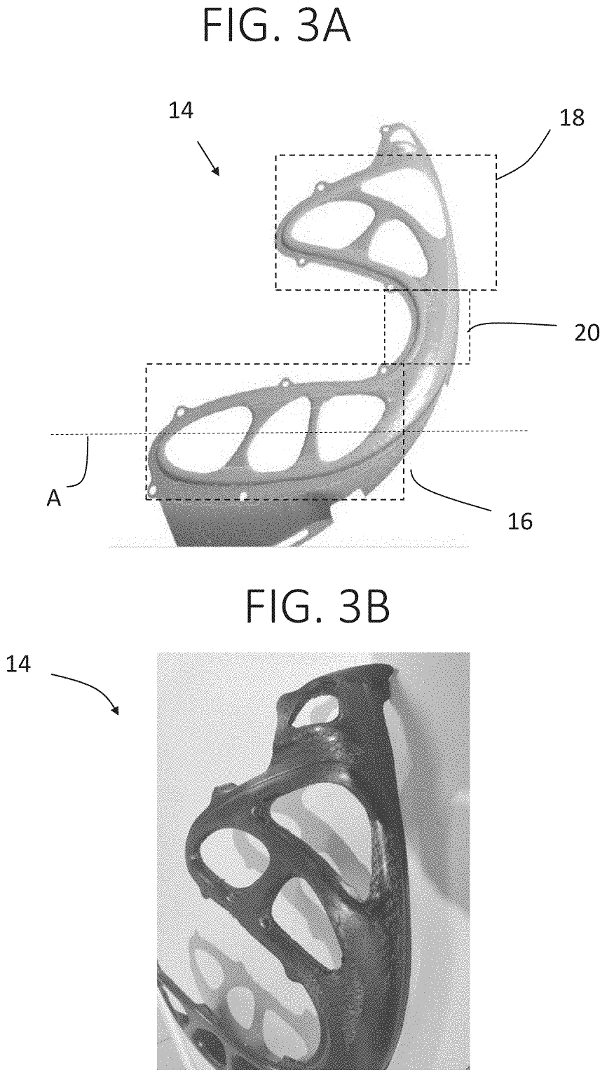

Left sidewall 14 is depicted separately in FIGS. 3A and 3B. Right sidewall 12 and left sidewall 14 are mirror images of each other, similar to a person's right and left hands, and thus the depiction of left sidewall 14 can easily be translated to a depiction of the right sidewall 12. As used in this disclosure, the terms “right” and “left” are from the perspective of a theoretical occupant sitting in the child car seat. As can be recognized by those of skill in the art, from the perspective of a viewer of the car seat, the “right” and “left” directions are inverted.

The right sidewall 12 and right sidewall 14 are joined by at least one cross beam. In the embodiment of FIG. 1, lower beam 26 and upper beam 28 join the left sidewall 12 and right sidewall 14. Lower beam 26 is below the bottom region, and upper beam 28 is above the head retaining region. Advantageously, the beams 26, 28 provide a secure connection without taking up space in the middle of the child car seat frame 10 that could interfere with the functioning of the child car seat. Lower beam 26 and upper beam 28 need not be made of carbon fiber, and may be made of any suitable material, such as reinforced plastic, molded plastic, steel, or aluminum.

Each sidewall 12, 14, consists of a bottom region 16, a head retaining region 18, and a central region 20 connecting therebetween. The approximate boundaries between each of these regions are delineated in FIG. 3A.

Each sidewall 12, 14 has a perimeter defined by rib 11, circumferential rib 13 of the head retaining region 18, upper rib 15 of the bottom region 16, and lower rib 17 of the bottom region 16. Although the ribs 11, 13, 15, 17 are referred to here as separate elements, they are actually all part of a single, monolithic structure, as will be discussed further herein. As used in this disclosure, the term “perimeter” refers to a continuous line that can be traced around a sidewall 12, 14, along ribs 11, 13, 15, 17.

Each sidewall 14 also includes elements peripheral to the perimeter. For example, stabilizing extension 22 extends from the bottom region 16 and provides support for stabilizing the car seat base 10 on the seat of a vehicle. Stabilizing connection 22 also provides a connection point for lower cross beam 26. Head retaining region extension 24 includes, inter alia, a connection point for upper cross beam 28. Both stabilizing extension 22 and head retaining region extension 24 may be produced monolithically with the rest of sidewalls 12, 14.

Each bottom region 16 includes at least one hollow space 32. Similarly, the head retaining region 18 includes at least one hollow space 34. In the illustrated embodiment, approximately 30% of the surface area of each sidewall 12, 14, is hollow space. In particular, at least 20% of the surface area of the bottom region 16, and at least 20% of the surface area of the head retaining region 18, is hollow space. The presence of hollow space in this quantity is advantageous, because the required amount of carbon fiber is reduced, and correspondingly the cost of production of the sidewall 12, 14, is reduced. In alternative embodiments, between 10% and 90% of the surface area of sidewalls 12, 14 is hollow space. A sidewall that is more than 90% hollow is not likely to be strong enough to withstand impacts. Conversely, a sidewall that has less than 10% hollow has too much carbon to be cost-effective.

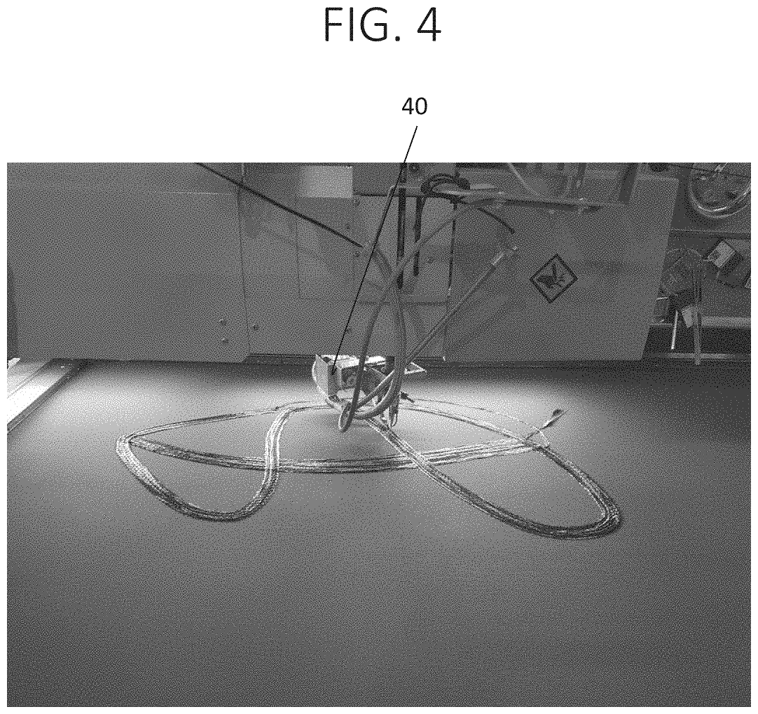

In the embodiment of FIGS. 1 and 2, there is no hollow space in the central region 20. In alternative embodiments, central region 20 may have a hollow space formed therein. For example, the patterns of carbon fibers depicted in FIGS. 4, 5A, 8B, and 8C would be used to form a sidewall with a hollow space in the central region 20.

In the illustrated embodiment, there are three holes 32 in each bottom region 16 and three holes 34 in each head retaining region 18. The holes 32 in each bottom region 16 are substantially aligned on a horizontal axis A of the bottom region 16, as shown in FIG. 3A. Each bottom region 16 is bounded by upper rib 15, lower rib 17, and at least one strut 21 oriented substantially perpendicular to the horizontal axis. The struts 21 provide added structural support to the sidewall 12, 14, as compared to a structure with one large hole and no struts. The ratio of a width of strut 21 to its height may vary, based on the strength requirements for the car seat base; for example, the ratio may be anywhere within the range of 10% to 200%.

Referring now to FIGS. 4-8C, a process of manufacturing each sidewall 12, 14 is now discussed. The design of the frame 10 is based on minimal use of carbon while optimizing the direction of carbon fibers. This is done, in some embodiments, by placing carbon fiber and polymers to form a carbon fiber preform having a plurality of layers, each with a predefined orientation. The fibers of each layer are placed in the exact direction required to optimize the stress distribution. More specifically, the approach is to use embroidery techniques that allow controlling the direction of every fiber and thereby achieve maximal optimization. The child car seat is thus manufactured with a smaller amount of carbon fiber, rendering the manufacturing less expensive, without compromising on the structural integrity of the car seat base. As an additional advantage, it is possible to minimize the structure width, allowing more space for the child while minimizing the total width of the seat.

FIG. 4 depicts a machine 40 that deposits carbon fiber onto a substrate using tailored fiber placement. While not the only way to manufacture the sidewalls 12, 14 of the present disclosure, tailored fiber placement is advantageous in that it allows for an efficient deposit of carbon fibers in predetermined patterns. This allows for the production to take place with virtually no waste. In a preferred embodiment, a commingled yarn is spun with carbon fiber and a polymer, and the commingled yarn is embroidered onto a substrate with tailored fiber placement. The use of commingled yarn is advantageous in that there is no additional step of placement of the polymer following placement of the carbon fiber layers. Such a subsequent placement step of the polymer could be technically challenging because the carbon fiber itself is not deposited in the form of a planar sheet. However, other methods of depositing the polymer may also be used, for example, application of a resin with a brush or a machine, or injection of polymer onto a carbon fiber preform that is made only of fibers. The polymer may be any suitable polymer, such as polypropylene, polyamide, poly-lactic acid, nylon, or any combination thereof.

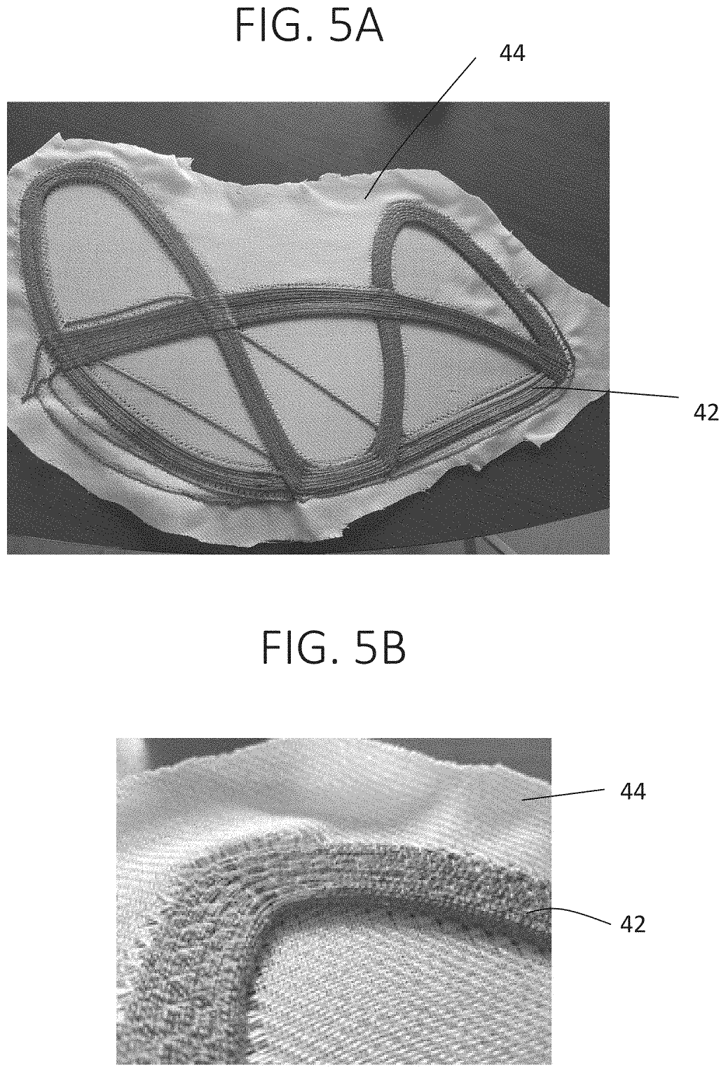

As shown in FIG. 5A and FIG. 5B, the carbon fiber, which may be a commingled yarn, is embroidered in a curvilinear pattern 42 onto a substrate 44. The resulting pattern 42 is thus formed in two dimensions on the substrate 44. The pattern 42 may correspond to a part of, or the entirety of, a sidewall 12, 14. Optionally, the pattern 42 may be formed from a single strand of carbon fiber or commingled yarn, which is looped in a continuous loop around the perimeter of the pattern 42. An advantage of forming the pattern with continuously applied fibers is that when the fibers follow the geometry of the sidewall 12, 14, it gives the structure of the sidewall much more strength, and in particular in curve (arc) areas, where a traditional woven sheet can break.

The substrate 44 may be, for example, a nylon cloth or another suitable material. However, any type of substrate may be used.

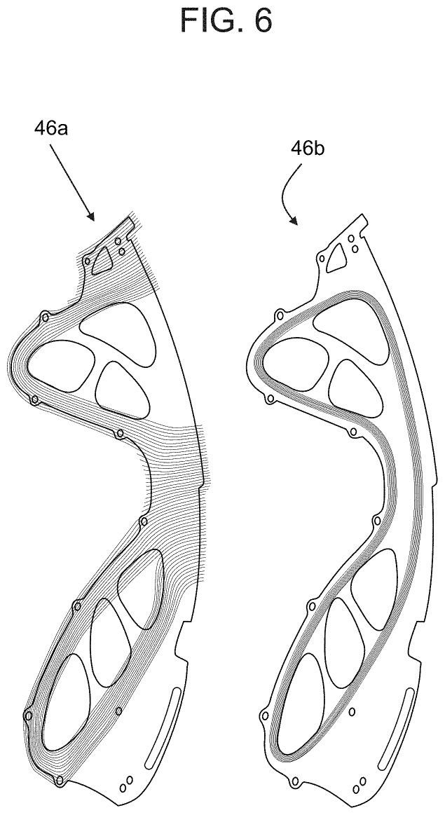

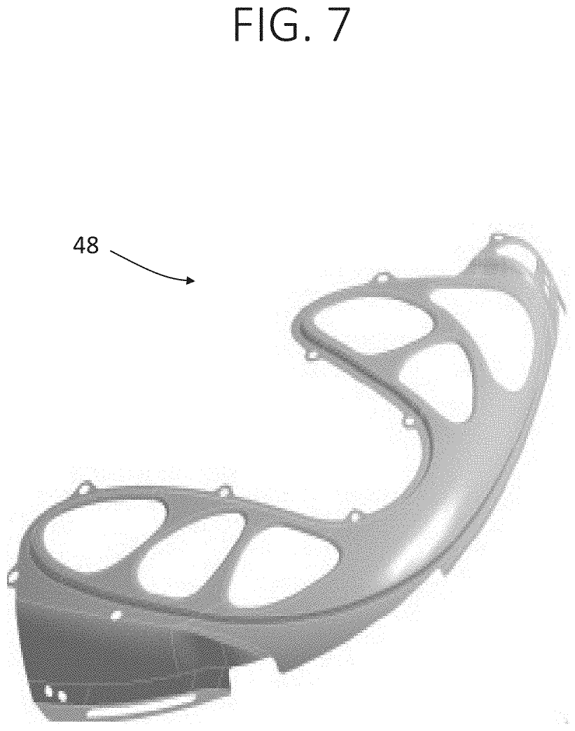

FIG. 6 shows two layer patterns 46a, 46b into which the carbon fiber or commingled yarn may be placed. The layer patterns 46a, 46b are overlaid over each other to produce a preform 48, as shown in FIG. 7. The depicted layer patterns 46a, 46b are merely exemplary, and a different number of layer patterns, or layer patterns oriented in different patterns, may also be employed. Each of the patterns 46a, 46b includes carbon fibers that are oriented in different directions. This placement of carbon fibers in multiple orientations is advantageous, because it enables the resulting sidewall to withstand impacts from multiple angles. The patterns 46a, 46b may be made using a one long fiber which does not require weak connecting points or waste of material. The fibers are placed in a predefined orientation, and may be placed in accordance with the stress lines on each sidewall 12, 14. The direction of the fibers may be determined on the basis of analysis and design. The thickness of carbon fiber layers 46a, 46b may be, for example, a maximum of 2 millimeters.

In addition, layer 46b is formed in a closed geometric shape that encompasses the head retaining region 16, the central region 20, and the bottom region 18. This layer is important for ensuring the structural integrity of the entire sidewall 12, 14, i.e., ensuring that the regions 16, 18, 20 stay connected with each other, even in the presence of a force resulting from lateral impact against the sidewall 12, 14.

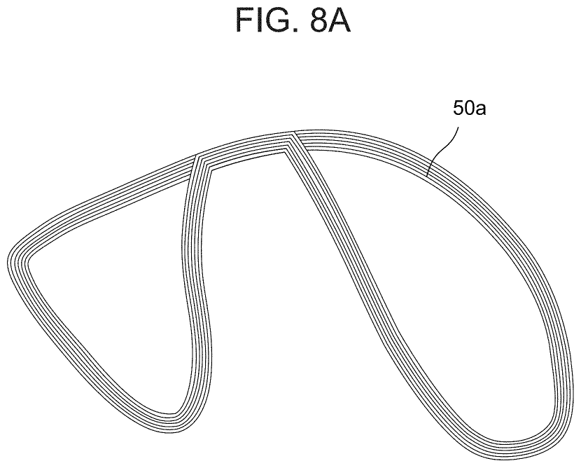

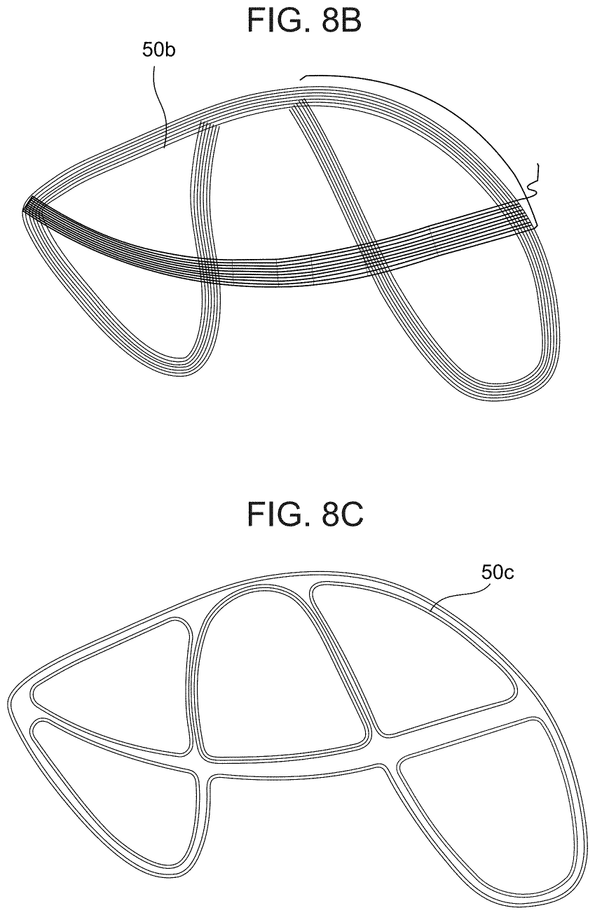

FIGS. 8A-8C depict alternative patterns 50a-50c that may be used in forming a preform 48. As discussed above, patterns 50b and 50c include a hollow space in the central region of the patterns. The providing of these examples of patterns is not meant to be limiting, and other patterns may also be used.

After the preform 48 is formed, it is heated or cured, in any manner that is known to those of skill in the art. A mold may be used to shape the two-dimensional preform into three-dimensions during the heating or curing. The mold may be a two-sided mold. Molding into a three-dimensional shape is valuable because the three-dimensional design adds structural stiffness to the frame. A 3D surface shape is much stronger than a flat shape, so it is desired to avoid flat walls to increase the moment of inertia. As a result of the heating or curing, the polymer forms a matrix that binds the carbon fiber layers, resulting in a monolithic, multilayered sidewall 12, 14. The cumulative surface area of the carbon fiber ribs forming the sidewalls 12, 14 may be, for example, 0.5 square meters (sqm) and optionally as small as 0.05 sqm.

Optionally, additional strengthening materials may be added during the heating or curing. For example, metal inserts may be heated or cured together with the carbon and polymer. Likewise, a plastic layer may be over-molded onto the preform 48 during the heating or curing process. These materials may provide additional structural support beyond that which is provided by the carbon fibers and polymer matrix.

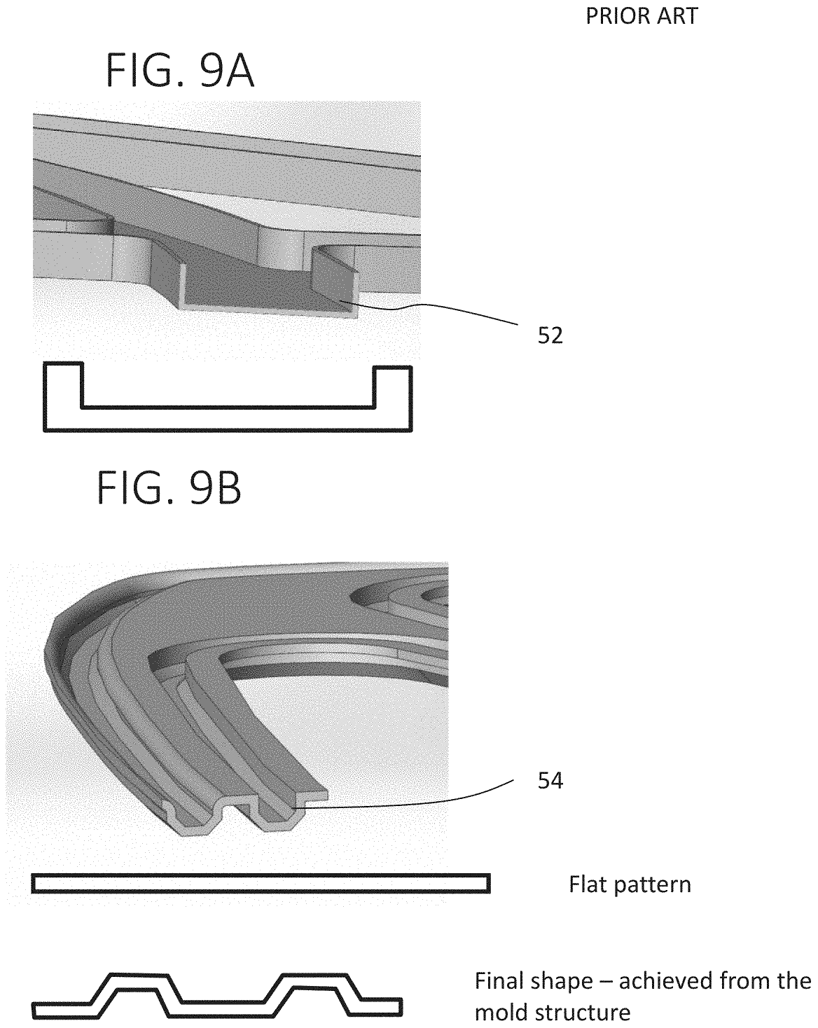

Referring now to FIGS. 9A-11C, certain features of the curvilinear ribs 11, 13, 15, 17 are discussed in further detail. As discussed above, during the curing process, the two-dimensional preform is shaped into a three-dimensional sidewall. During this process, a concave indentation is formed on an underside of the preform, for example, with a mold.

In carbon fiber reinforced polymers, right-angle turns or U-shaped turns 52 such as those shown in FIG. 9A are disfavored. Because carbon fibers are strongest only against a force applied in a single direction, turning the carbon fibers by 90 degrees results in a weakened spot at the point of the turn. The carbon fibers themselves are weakest when turning. Due to these consideration and production limitations, it is not possible to have 90 degree walls on both sides of a concave portion of a rib, as is usually designed (shown for example in FIG. 9A). Instead, a rib with a curved surface with one or two concave ‘punches’ or indentations to strengthen the structure, or a W-shaped cross section 54 is used. Such a rib with a W-shaped cross section 54 is shown for example in FIG. 9B, with angles of approximately 30 degrees. In addition, strengtheners may be introduced in the middle of the rib that are formed during the curing stage.

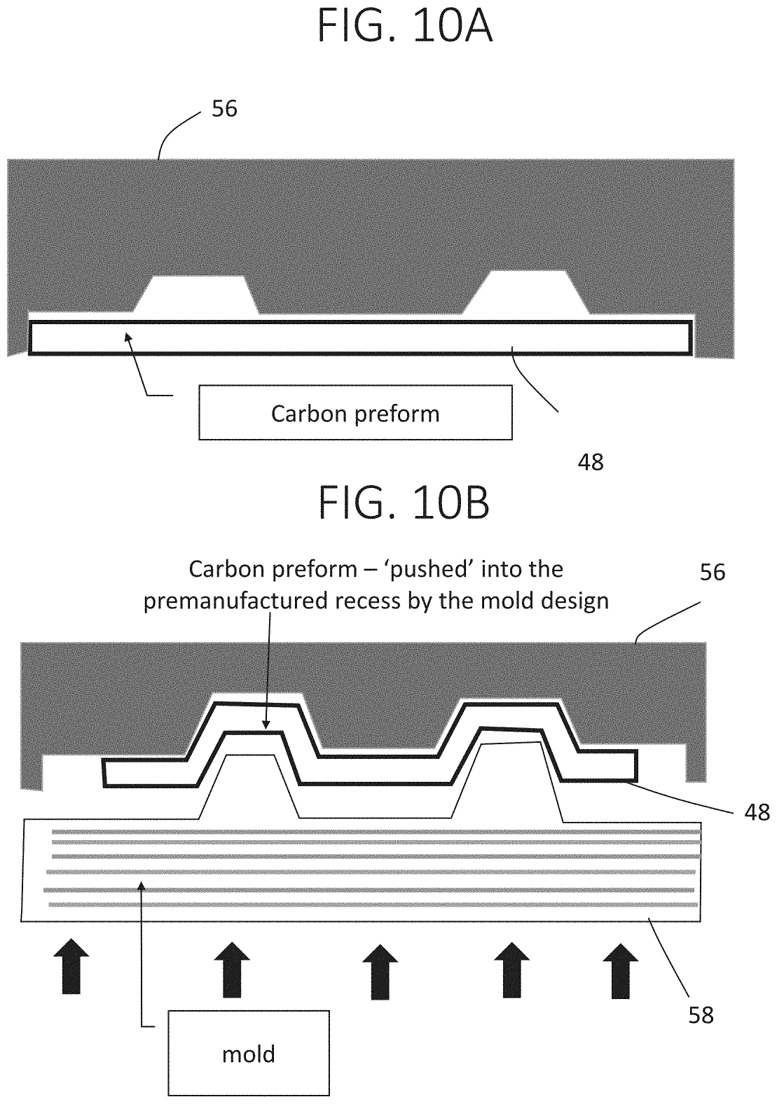

FIGS. 10A and 10B depict the operation of a two-part mold 56, 58 in the formation of a concave indentation on a rib. A mold part 56 is manufactured with a recess. The carbon fiber perform 48 is arranged adjacent to the mold part 56. This may occur outside of the mold part 58. Mold part 58 is then placed in position and heated. The heated mold is designed to “push” the carbon perform 48 into the premanufactured recess, thereby producing a W-shaped concavity.

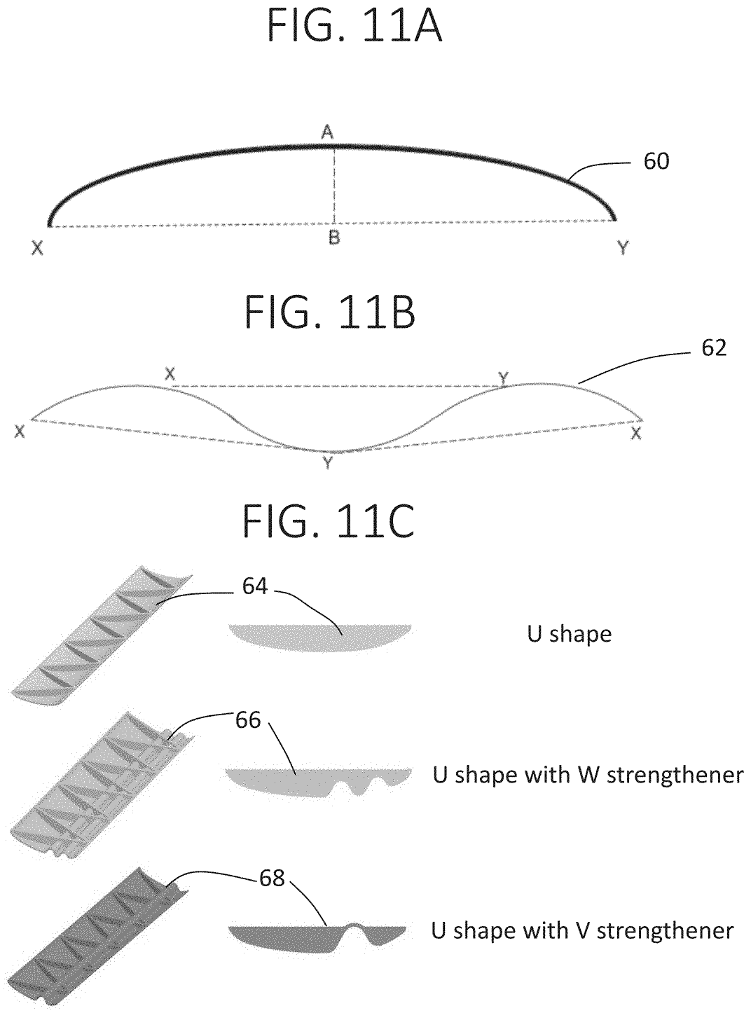

FIGS. 11A, 11B and 11C show examples of curved ribs, such as ribs 11, 13, 15, and 17. The surface of the rib in FIG. 11A has a curve shape 60 in a section view to create a C shape, as demarcated by axes X-Y and A-B. The height of the rib (AB) may be, for example, no more than 50% of width of the rib (XY). The surface of the rib in FIG. 11B has a wave shape, defining three concave portions (one pointing upward, two pointing downward) that are each demarcated by axes X-Y.

While the polymer matrix provides support to the underside of the concave portions, it is possible to provide further structural support by adding plastic strengtheners. FIG. 11C depicts three possible undersides of a rib. Rib 64 has a simple U-shaped underside 64. Rib 66 has a U-shape with a W-shaped strengthener. Rib 68 has a U-shape with a V-shaped strengthener. The V-shaped plastic strengtheners are added in the concaved area of the carbon rib surface, basically perpendicular to the surface. The strengtheners may be V-shaped, with angles between 3 degrees to 75 degrees in the center, and may be made, for example, from plastic material of the same type as the polymeric material that connects the carbon fibers.

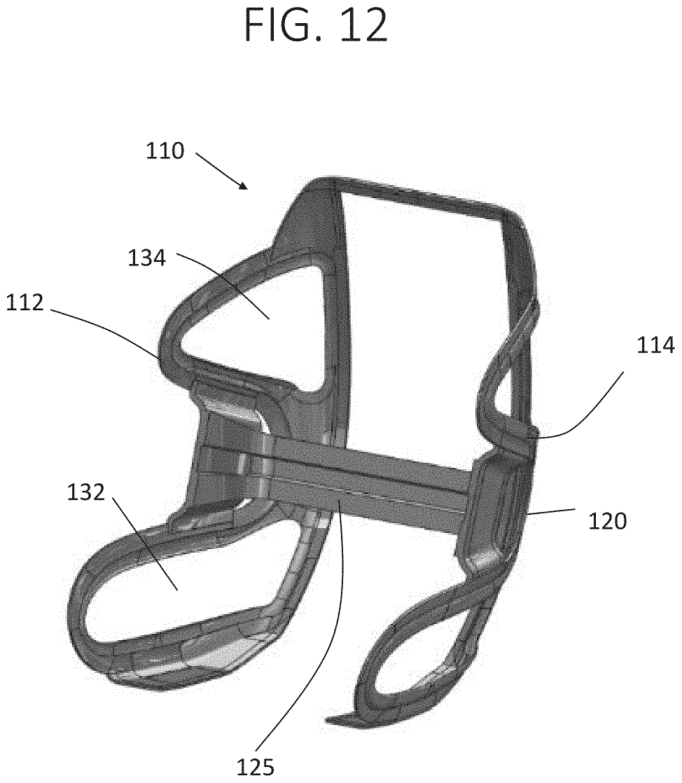

FIG. 12 depicts a second embodiment 110 of a child car seat base, according to embodiments of the invention. In most respects, car seat base 110 is constructed and manufactured similar to car seat base 10. The main differences of child car seat base 110 is that side walls 112, 114 are joined by a single cross beam 125, which is attached to central region 120 of each side wall. In addition, hollow spaces 132, 134 are formed as single, larger spaces, rather than being subdivided into multiple holes.

It is expected that during the life of a patent maturing from this application many types of polymers and plastics will be developed that are suitable for the functions described herein, and the scope of the terms polymer and plastic is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A child car seat, comprising:
a curvilinear frame comprising:
right and left monolithic multilayered carbon fiber sidewalls each is embroidered from carbon fibers arranged in a curvilinear pattern and having a head retaining region and a bottom region connected by a central region; and
at least one beam connecting one of the right and left monolithic multilayered carbon fiber sidewalls with the other;
wherein at least 20% of the surface area of each of the head retaining region and the bottom region is a hollow space.

2. The child car seat of claim 1, wherein each sidewall comprises at least one rib with a curved surface, wherein at least a portion of the curved surface has a concave indentation.

3. The child car seat of claim 2, further comprising at least one V-shaped plastic strengthener attached to the concave indentation.

4. The child car seat of claim 1, wherein the hollow space in the bottom region comprises two or more holes, wherein said holes are substantially aligned on a horizontal axis of the bottom region, and each hole is bounded by an upper rib, a lower rib, and at least one strut oriented substantially perpendicular to the horizontal axis.

5. The child car seat of claim 1, wherein a ratio of a width of each strut to its height is between 10% and 200%.

6. The child car seat frame of claim 1, wherein, for each sidewall, the hollow space of the bottom region has at least three bottom region holes, and the hollow space of the head retaining region comprises at least three head retaining holes.

7. The child car seat frame of claim 1, wherein the at least one beam comprises an upper beam joining the sidewalls above the head retaining region, and a lower beam joining the sidewalls below the bottom region.

8. A child car seat, comprising:
a curvilinear frame comprising:
right and left monolithic multilayered carbon fiber sidewalls each is embroidered from carbon fibers arranged in a curvilinear pattern and having a head retaining region and a bottom region connected by a central region; and
at least one beam connecting one of the right and left monolithic multilayered carbon fiber sidewalls with the other;
wherein each of the right sidewall and the left sidewall comprises at least one bottom region hollow space and at least one head retaining region hollow space;
wherein the right sidewall and left sidewall are each manufactured by the following process:
placing carbon fibers and polymer to form a carbon fiber preform having a plurality of layers, each with a predefined orientation; and
heating or curing the carbon fiber preform so that the polymer forms a matrix that binds the plurality of carbon fiber layers.

9-14. (canceled)

15. The child car seat of claim 8, wherein at least one of the plurality of carbon fiber layers is formed in a closed geometric shape that encompasses the head retaining region, the central region, and the bottom region.

16. The child car seat of claim 8, wherein the carbon fiber and polymer are in the form of a commingled yarn during the placing step.

17. The child car seat of claim 8, wherein each of the right and left sidewalls further comprises metal inserts that are heated or cured together with the carbon and polymer.

18. The child car seat of claim 8, further wherein each of the right and left sidewalls further comprises a plastic layer that is over-molded onto the carbon fiber preform during the heating or curing process.

19. A method of manufacturing a child car seat, comprising:
forming right and left monolithic multilayered carbon fiber sidewalls, wherein each of the right sidewall and the left sidewall is embroidered from carbon fibers arranged in a curvilinear pattern and comprises at least one bottom region hollow space, and at least one head retaining region hollow space; and
joining the right sidewall and the left sidewall with at least one beam;
wherein the forming step comprises:
placing carbon fibers and polymer to form a carbon fiber preform having a plurality of layers, each with a predefined orientation; and
heating or curing the carbon fiber preform so that the polymer forms a matrix that binds the plurality of carbon fiber layers.

20. The method of claim 19, wherein at least 20% of the surface area of each of the head retaining region and the bottom region is a hollow space.

21-24. (canceled)

25. The method of claim 19, further comprising embroidering at least one of the plurality of carbon fiber layers in a closed geometric shape that encompasses the head retaining region, the central region, and the bottom region.

26. (canceled)

27. The method of claim 19, wherein the carbon fiber and polymer are in the form of a commingled yarn during the placing step.

28. The method of claim 19, wherein the heating or curing step further comprises heating or curing metal inserts together with the carbon and polymer.

29. The method of claim 19, further comprising over-molding a plastic layer onto the carbon fiber preform during the heating or curing step.

30. The child car seat of claim 8, wherein at least 20% of the surface area of each of the head retaining region and the bottom region is a hollow space.

31. The method of claim 19, wherein the hollow space of the bottom region has at least three bottom region holes, and the hollow space of the head retaining region comprises at least three head retaining holes.
